(19) United States
(12) Patent Application Publication
(10) Pub. No.: US 2025/0128638 A1
(43) Pub. Date: Apr. 24, 2025

(54) Hangar and Arrangement for Changing a Battery from an Aircraft

(71) Applicant: H I V E SYSTEMS GMBH, Nuremberg (DE)

(72) Inventors: Tristan Scheler, Nuremberg (DE); Dominik Blümm, Tuchenbach (DE)

(21) Appl. No.: 18/683,098

(22) PCT Filed: Aug. 9, 2022
(86) PCT No.: PCT/EP2022/072337

§ 371 Date: Feb. 12, 2024

(30) Foreign Application Priority Data
Aug. 10, 2021 (DE) 10 2021 120 783.5

(51) Int. Cl. B60L 53/80; B60L 53/35; B64U 50/19; B64U 50/39; H01M 50/249; H01M 50/264

(52) U.S. Cl. CPC B60L 53/80; B60L 53/35; B64U 50/19; B64U 50/39; H01M 50/249; H01M 50/264; B60L 2200/10

(57) ABSTRACT

The preferred embodiments disclose a hangar comprising a gantry robot which includes a lifting tool. The gantry robot is provided for lifting and lowering batteries to replace them, for example, in a drone disposed in the hangar.

### BACKGROUND OF THE INVENTION

### Field of the Invention

The invention relates to an assembly for removing a battery from a vehicle and for inserting a battery into the vehicle, specifically an aircraft. Further, the invention relates to a hangar comprising an assembly of this type.

### Description of Related Art

From prior art, aircraft in the form of unmanned drones are known. Such a drone can be in the form of a multicopter, for example, and can be supplied with energy via a battery in the form of an accumulator. From prior art, furthermore devices are known via which the battery can be automatically removed from and inserted into the drone.

### SUMMARY

On the other hand, the object underlying the invention is to provide an assembly for removing a battery from a vehicle and for inserting a battery into the vehicle which has a simple and inexpensive design in terms of devices and can be easily operated. Moreover, it is the object of the invention to provide a hangar comprising such an assembly. In addition, an assembly is to be provided including a battery holder and a battery for an aircraft which enable replacement of a battery in a simple and inexpensive manner in terms of devices.

The object with respect to the assembly for removing and inserting the battery is achieved according to the features of claim 1, with respect to the hangar is achieved according to the features of claim 9, and with respect to the assembly including the battery holder and the battery is achieved according to the features of claim 10.

Advantageous developments of the invention are the subject matter of the subclaims.

In accordance with the invention, there is provided an assembly for removing a battery, specifically in the form of an accumulator, from a vehicle and for inserting a or the battery into the vehicle. The vehicle preferably is an aircraft. The assembly includes a robot which advantageously has a lifting tool. Said tool can be movable by means of the robot and can be provided for holding and moving the battery. Thus, a change in position of the battery can be carried out by the robot. Moreover, the assembly has at least one battery or energy storage for the vehicle. The battery has a battery housing on which a lifting means adapted to be gripped by the lifting tool can be configured. In addition, a battery holder which can be fastened or tightly fixed to the vehicle via a fastener may be provided. The battery holder preferably includes a battery compartment into which the battery can be inserted and from which it can be removed through the lifting tool. Advantageously, the robot is a gantry robot in a device-related simple and inexpensive manner which includes a gantry arm with the lifting tool.

A gantry robot of this type is, apart from its device-related simple configuration, also easily controllable, for example compared to a robot arm having plural actors. The gantry robot can be used in a space-saving manner and can preferably be disposed above the aircraft to remove the battery from or insert it into the aircraft by its lifting tool. The simple and space-saving configuration allows such gantry robot and the assembly, resp., to be also inserted easily into a hangar which in this way can be designed to be compact, as will be explained in detail below. In addition, comparatively high loads can be moved by a gantry robot. Further, a gantry robot is by far cheaper than a robot arm having several axes or 7 axes, for example. A gantry robot is also easily scalable in terms of its size.

Preferably, for the assembly there is provided a work surface or mounting surface accessible from the top, specifically as seen in the vertical direction, on which the vehicle can be arranged. The lifting tool preferably can be arranged above the work surface to lift the battery upwards out of the vehicle or to insert the battery into the vehicle from above. It would be conceivable that the vehicle, such as in the form of the aircraft, arranges itself on the work surface and moves away from the work surface by its own means. The simple and space-saving design of the gantry robot helps create generous maneuvering space for this purpose. Alternatively, or additionally, the work surface can be provided to be displaceable via an appropriate device such as a conveyor belt.

The lifting tool has a device-related simple and inexpensive design as a gripping tool. In this way, the battery can be safely gripped for removal and insertion thereof. It is alternatively or additionally conceivable to provide a magnet, for example, as a lifting tool.

The gantry robot is preferably designed as a gantry area robot. A slide can be movable specifically in an x-y plane or horizontal plane or in a plane transversely to the lifting direction of the gantry arm or in plane at a parallel distance from the work surface. In this way, the lifting tool can be moved flexibly over a large surface so as to replace batteries, for example, or to transport batteries to a storage place or charging place. The gantry arm can be supported to be movable in its axial direction by means of the slide. The gantry arm is movable via an actor preferably in a vertical direction or up-down direction or in a vertical axis. Of preference, the gantry arm extends in the vertical direction. The lifting tool can then be provided at the end side in the lower area of the gantry arm. The lifting tool in the form of the gripping tool can face downwards, for example. As already mentioned above, the vehicle including the battery holder and/or the work surface is preferably arranged below the lifting tool and/or the gantry robot.

As an alternative to the gantry area robot, it would also be imaginable to use a line gantry robot having a crossbeam. Accordingly, it is further imaginable that the work surface is movable at least transversely to the crossbeam to position the battery in this direction relative to the lifting tool.

The gripping tool preferably simply includes two gripper jaws which can be operated via an actor. The actor can be operated electronically and/or hydraulically and/or pneumatically, for example. The axis of rotation of the gripper jaws extends, e.g., transversely to the vertical axis and/or in parallel to the crossbeam of the slide.

Preferably, at least one sensor connected to a control unit is provided to detect the lifting means of the battery case. In this way, the lifting tool can get selectively and automatically to the lifting means and can remove the battery from the battery compartment. It is further imaginable to provide the sensor or another sensor to detect the, particularly empty, battery compartment so that the robot can automatically insert the battery into the battery compartment via the lifting tool. Alternatively, or additionally, for replacing the battery, the battery case can be provided to be arranged at a predetermined position and with a predetermined orientation.

The battery compartment preferably has a compartment opening accessible from above, in particular when the vehicle is arranged for removal or insertion of the battery. Through the compartment opening, the battery can be insertable and removable. In a further configuration of the invention, the compartment opening can be accessible so that a battery held by the lifting tool can be inserted through the compartment opening into the battery compartment by appropriately controlling the robot and that a battery can be gripped by the lifting tool and can be removed through the compartment opening from the battery compartment by appropriately controlling the robot.

Of advantage, the battery holder is box-shaped in a device-related simple manner. The battery compartment may be provided to have a bottom surface from which plural inner wall surfaces extend away to the compartment opening. The compartment opening and the bottom surface then are superimposed, for example, and extend equally spaced from each other. Further preferred, four inner wall surfaces are provided which, viewed in cross-section, i.e., in a section parallel to the bottom surface, may form a rectangle. Two of the inner surfaces can be designed as large inner surfaces. They are preferably facing each other. Two smaller inner wall surfaces may be provided transversely thereto and may be equally facing each other.

In a further configuration of the invention, the battery compartment can be advantageously provided to taper from the compartment opening, particularly viewed in the up-down direction. In this way, centering of the battery, specifically during insertion, can be easily possible. In other words, the battery compartment tapers downwards so that the battery can be easily threaded.

In a further configuration of the invention, the battery compartment, specifically the inner surfaces of the battery compartment, and/or the battery holder can be substantially truncated pyramid-shaped or truncated cone-shaped or can have a or a respective truncated pyramid-shaped or truncated cone-shaped centering section. In this way, the tapering of the battery compartment can be realized in a device-related simple manner. The bottom surface, specifically in the form of a cover surface, of the battery compartment is preferably arranged at the bottom with the inner surfaces extending upwards and the distance of the inner surfaces increasing from the bottom to the top relative to each other. Each of the inner surfaces is preferably trapezoidal. On an upper side of the battery compartment, then the compartment opening is formed which is delimited by an inner surface.

The battery compartment may be provided, alternatively or additionally, to have a lower base section connected—from the bottom—to the upper centering section. The base section may have a differing shape compared to the centering section so that the battery compartment, on the one hand, fulfils the centering function via the centering section and, on the other hand, through the base section can be designed corresponding to a space required, such as to flexibly accommodate electronic parts. The base section is preferably sleeve-shaped, wherein at the top the shell-type centering section is connected to its walls enclosing the bottom surface. A length—viewed in the up-down direction or viewed in the inserting direction of the battery—of the centering section is larger or substantially larger than a length of the base section, thus allowing large tolerance for centering the battery.

In other words, the battery compartment and/or the battery holder is box-shaped and is open at the top toward the compartment opening and is limited at the bottom by a base, in particular when the vehicle is arranged on the work surface below the gantry robot. Walls of the battery holder and/or the inner surfaces of the battery compartment can move away from each other starting from the base. The bottom surface preferably has an approximately elongated rectangular shape with two long and two short sides.

In a further configuration of the invention, contacts are formed in/at the base of the battery compartment. They interact with contacts of the battery in the inserted state of the battery. Preferably, the contacts of the battery/batteries of the battery compartment are in mechanical contact. The base of the battery compartment preferably has a through-hole through which the contacts, specifically formed on a printed circuit board or PCB, are accessible.

The contacts are in the form of contact surfaces, for example. As an alternative, or in addition, it is conceivable that the contacts are arranged in one or more line(s) or in a matrix shape.

Of advantage, the battery case has a frustoconical and/or box-shaped design. The battery case may have an upper, specifically outer, base area and a lower, specifically outer, cover area. Therebetween specifically trapezoidal outer surfaces can be provided. They can approach each other starting from the upper side. In other words, a circumferential wall of the battery case tapers as viewed in an up-down direction. Such a design of the battery case allows to insert the battery easily into the battery compartment. The tapered design of the battery case permits a large tolerance range. Further preferred, the circumferential wall tapers with a centering section extending downwards away from a base section of the circumferential wall. In other words, the battery case has an upper base section and a lower centering section. Outer surfaces of the centering section of the battery case are preferably adjusted to the inner surfaces of the centering section of the battery holder so that centering is possible.

Preferably, the battery case additionally includes a contact section connected from the bottom to the centering section. Said contact section has a preferably hollow-cylindrical shape. Alternatively, or additionally, the contact section has an outer diameter and/or outer cross-section corresponding to the minimum outer diameter and/or minimum outer cross-section of the centering section. The battery case and the battery holder are preferably designed so that the contact section of the battery in the inserted state immerses into the base section of the battery holder. Where needed, an immersion depth can be provided to be limited by the contact section being adjacent to an upwardly facing contact shoulder of the base section with its downwardly facing front end.

The battery case can be made up of multiple parts, wherein the base section forms one component and the centering section—optionally together with the contact section—forms another component. This allows the sections to be manufactured flexibly and independently of each other.

In a preferred configuration, the base section of the battery case protrudes completely or at least partly after insertion into the battery holder so that the battery has a space which is not arranged in the battery holder. In this way, a capacity of the battery can be easily increased.

The base section of the battery case preferably has a radial collar which extends outwardly and, when the battery is inserted in the battery holder, covers a gap between the battery and the battery holder. The covering is preferably completely peripheral around the battery and the battery holder. The radial collar can extend outwardly and downwardly in a roof shape away from the battery case and encompass the centering section. It would also be conceivable that, when the battery is inserted in the battery holder, the radial collar engages behind or overlaps the battery holder to offer even better protection.

The battery can include contacts at the lower cover surface of the battery case. They preferably interact with the contacts of the battery holder. When the battery is inserted, the contacts of the battery and the contacts of the battery holder can mechanically contact each other, which enables current flow and/or voltage application and/or allows for data exchange.

Preferably, the battery includes, on its lower side or lower cover surface, a printed circuit board extending preferably transversely to an up-down direction. The printed circuit board has an outer large surface which faces outwardly and a large surface which faces inwardly—and preferably downwardly—. The outer large surface has at least one contacting section including the contacts which is accessible from outside. The contacts of the battery thus are formed on the contacting section. When the battery is mounted in the battery holder, the printed circuit board of the battery and the printed circuit board of the battery holder can extend in parallel distance to each other.

In a preferred embodiment of the invention, contact faces are formed as contacts in the battery and are mechanically and/or electrically connected to the printed circuit board, the contact faces extending obliquely or perpendicularly away from the printed circuit board. Moreover, in the battery holder a respective contact spring is formed for each contact face and is tightly connected to the printed circuit board of the battery holder. The respective contact face and the respective contact spring interacting with the former are adjacent to each other when the battery is mounted in the battery holder. This solution offers the advantage that a mechanical force and tension which, as a result of contacting, acts on the respective contact face and the interacting contact spring does not act directly, viz. perpendicularly, upon the printed circuit board. It has turned out that, particularly at higher operating temperatures, otherwise a deformation of the printed circuit board or the case supporting the printed circuit board may occur. The oblique or perpendicular arrangement of the contact faces thus prevents the forces and tensions from acting directly in the direction of the printed circuit board.

Preferably, the contact faces are provided at the battery and the contact springs are provided at the battery holder, as explained above. The contact springs are mechanically more sensitive and are more susceptible to damage. By the arrangement in the battery holder, they are arranged to be comparatively protected. The more robust contact faces are provided on the battery as, by replacement of the battery, the latter is more likely to get into mechanical contact with other components. As a matter of course, it is nevertheless possible vice versa to provide the contact springs on the battery and the contact faces on the battery holder or to create a combined form.

Preferably, at least one contact pairing is provided having two of the above-illustrated contact faces with each of which one of the above-illustrated contact springs is associated. One contact face with one contact spring forms a plus pole and the other contact face with the further contact spring forms a minus pole. The respective contact face is advantageously part of a respective contacting plate. Each of the latter is tightly connected to the printed circuit board, such as by a soldered connection. The contacting plates extend preferably in or substantially in parallel distance to each other and/or perpendicularly and/or in the mounting direction to the printed circuit board. Consequently, the respective contact spring can slide on the respective contact face when the battery is mounted/inserted or removed. The respective contact spring is preferably designed as spring leg which is tightly connected to the printed circuit board, e.g. by a soldered connection. The spring leg has a first end-side leg portion and a second leg portion arranged relative to—preferably connected to—the former which are V-shaped relative to each other. The connecting area of the leg portions is adjacent to the contact face after insertion of the battery in the batter holder, causing the spring leg to be tensioned. The end-side leg portion is bent obliquely to the contacting area and, viewed in the plane of the contacting area, protrudes away therefrom so that, when inserting the battery, the spring leg is tensioned over the end-side leg portion and, thus, the latter can act as a type of ramp.

The contact faces of the contact pairing may face each other, for example, and limit a receiving space for the contact springs, which results in a robust design.

Further preferred, several or plural contact pairings are provided.

The contact plates or contact faces can be arranged in a connector block which is made, e.g., of an electrically insulating material, preferably plastic material. The connector block can be fastened to the printed circuit board by the contact faces. The contact plates or contact faces preferably rest on the connector block. For the or a respective contact pairing, the connector block further preferably has a block opening through which the contact springs can be inserted. The contact springs can preferably be arranged in a connector receiving block which is made of an electrically insulating material, preferably plastic material. The connector receiving block is preferably fastened to the printed circuit board by the contact springs. The contact springs preferably rest on the connector receiving block. Further preferred, the contact springs are—preferably peripherally or completely peripherally-enclosed by the connector receiving block and/or the contact plates or contact faces are—preferably peripherally or completely peripherally-enclosed by the connector block so that said components are mechanically protected by the respective blocks. Vice versa, it would be conceivable that the connector block is provided at the contact springs and the connector receiving block is provided at the contact plates or contact faces. The connector block and the connector receiving block help provide an additionally positive connection, whereby the quality of contacting is extremely high even in adverse conditions such as high temperature variations. In other words, the connector block and the connector receiving block are adjusted to each other—such as a plug and a socket—and can be positively connected to each other. Where needed, a non-positive connection can additionally be provided between the blocks in their assembled state.

In a further configuration of the invention, at least one centering pin is formed on the connector block and/or on the connector receiving block, specifically integrally therewith. When mounted, the centering pin immerses into a corresponding pin holder of the connector receiving block or connector block. The centering pin extends in the mounting direction and/or perpendicularly to the printed circuit board and/or in the up-down direction and protrudes from the block on which it is formed. Thus, when mounted, the centering pin immerses into the pin holder, before the connector block immerses into the connector receiving block. This results in additional mounting safety to avoid damage of the contacts. Further preferred, at least two centering pins having a corresponding centering holder are provided which are designed as illustrated before.

Advantageously, the tapered shape of the battery case and of the battery holder constitutes a pre-centering during insertion of the battery, with the centering pin/s subsequently providing a fine adjustment.

When the battery is inserted in the battery compartment, the cover surface of the battery and the bottom surface of the battery compartment can be opposite to each other. For example, said surfaces extend approximately in parallel distance to each other. It is further conceivable that at least parts of said surfaces are adjacent to each other.

In other words, the box-shaped battery holder and the box-shaped battery case are configured so that they can be stacked inside each other and/or nested.

In another configuration of the invention, the battery, when inserted, can be fixed via at least one lock or mechanical lock in the battery compartment, specifically with respect to the battery compartment. The lock is preferably designed so that it opens automatically when a predetermined force acts on the battery in the lifting direction. Alternatively, or additionally, the lock can be designed so that it closes automatically when the battery is inserted into the battery compartment. This allows extremely simple insertion and removal of the battery. No means are required to release or close the lock. In other words, the lock remains closed up to a predetermined clamping force or tightening force. The clamping force ranges from 22 to 100 N, for example. The at least one lock can be formed between the lower cover surface of the battery case and the bottom surface of the battery compartment. When the at least one lock is closed, the battery is kept preferably free of play in the battery compartment. The lock is a snap lock with an attractive effect, for example. Alternatively, or additionally, it would be conceivable to provide a magnetic lock as a lock. Further preferred, the lock applies the tightening force in the direction of the bottom surface to the battery. The tapered design of the battery compartment and the battery case causes the latter to be tightened against each other and to be positively fixed to each other.

The lock may have a hook fastened to the battery or the battery holder. Further, the lock may have a hook receptacle in which the hook is immersed in the closed state of the lock. The hook receptacle is then formed on the respective other component, i.e., on the battery holder or the battery. Further preferred, in the hook receptacle a holding mechanism for applying the tightening force to the hook is provided. The holding mechanism includes a lever having a spring, for example. The lever may be arranged rotatably in the hook receptacle. When inserting the battery, the lever is brought via the hook into a spring-biased closing position in which the hook is locked. The lever is formed and configured so that, when the battery is removed, the spring force must be overcome. If the lifting force-applied through the gantry robot-exceeds the spring force, the lever is moved into its opening position by the hook and the hook is released.

The hook is preferably formed on the battery holder and the hook receptacle is preferably formed on the battery. This is advantageous, because the hook is thus arranged to be protected in the battery compartment. Preferably, the hook protrudes from the bottom surface of the battery compartment. The hook receptacle can be accessible, in turn, from the lower cover surface of the battery case.

In another configuration of the invention, two locks are provided to safely fix the battery in the battery compartment and to create redundancy. Further preferred, two hooks are then provided, wherein a respective hook can be arranged adjacent to the respective small inner wall surface of the battery compartment and can protrude from the bottom surface. Between the hooks, the contacts can be designed in the area of the bottom surface. The hook receptacles are preferably provided in the lower cover surface of the battery case. Each of the hook receptacles is arranged preferably adjacent to a respective short side of the cover surface. The lock can be unlocked by the hook in the direction of the lifting force and can be closed by the hook in an opposite direction.

In a further configuration of the invention, the contacts or at least a part of the contacts of one component in the form of the battery or the battery holder can be designed as pins. Each of said pins can interact with one of the contacts of the other component in the form of the battery holder or the battery designed as contact face. A respective pin preferably has a spring which rests on the component and applies spring force to the pin. The pin may have a collar via which it rests in a spring-biased home position on a corresponding stop of the component, specifically when the battery is not inserted. The pin can be axially displaceable against the spring force, wherein during such displacement the collar moves away from the stop. Accordingly, the pin is pushed into the component. The pins can protrude from the component, specifically from the cover surface of the battery or from the bottom surface of the battery compartment, so that, when the battery is inserted in the battery compartment, they are tensioned via their respective spring against the opposite contact faces. This results in a safe contact in a device-related simple manner.

The contacts or at least part of the contacts are/is preferably designed for a power circuit. For example, it would be conceivable to conduct up to 180 A via said power circuit to power the aircraft.

In a further configuration of the invention, means for automatically and/or independently removing the battery from and inserting it into the battery compartment. In so doing, at least one sensor can be provided which can detect the position and/or orientation of the battery and/or which can detect the position of the lifting tool. Moreover, it is conceivable to provide means for automatically moving the vehicle to a position in which the battery can be removed and inserted. Preferably, a control unit interacting with the at least one sensor and being capable of controlling the gantry robot and/or the means is provided.

Further preferably, a battery storage is provided into which at least one battery can be inserted for charging or from which it can be removed via the gantry robot.

The vehicle preferably is an aircraft. In particular, the vehicle can be provided to be an unmanned aircraft. The aircraft is configured as a drone, specifically in the form of a multicopter, for example.

The multicopter is, e.g., a quadrocopter. The battery holder is preferably fastened to the aircraft in such a way that the battery compartment is accessible from above via the gantry robot, in particular when the aircraft is parked on the work surface. In the multicopter, the battery holder is preferably arranged between rotors on an upper side of the multicopter.

Further preferred, a plurality of battery compartments is provided to dispose plural batteries. They can be formed in a joint battery holder or in a respective battery holder.

It is further conceivable that, apart from the battery, at least one data storage is provided in the battery case. Said data storage can be connected to the vehicle or aircraft via the contacts and can act as a kind of flight recorder, for example.

A sensor system can be provided, for example in the aircraft, to collect data of the aircraft and/or the environment. These data can be written, e.g., into the data storage. It is also imaginable to monitor the battery via the sensor system.

The battery weighs about 2.5 kg, for example.

According to the invention, an assembly comprising a battery holder and a battery for an aircraft is provided. The battery holder includes one or more of the afore-mentioned aspects. Moreover, the battery includes one or more of the afore-mentioned aspects. In other words, the configurations of the battery and the battery holder stated in the application with respect to the assembly comprising the gantry robot can be provided correspondingly for this assembly.

According to the invention, a hangar comprising the assembly according to one or more of the afore-mentioned aspects is provided, the vehicle being an aircraft. Preferably, the assembly is disposed inside the hangar.

There is disclosed a hangar comprising a gantry robot which includes a lifting tool. The gantry robot is provided for lifting and lowering batteries to replace them in a drone disposed in the hangar, for example.

### BRIEF DESCRIPTION OF THE DRAWINGS

Preferred embodiments of the invention will be illustrated hereinafter in detail by way of schematic drawings, wherein:

FIG. 1 is a perspective view of a hangar comprising an assembly according to one embodiment,

FIG. 2 is a perspective view of a battery case and a battery holder according to one embodiment,

FIG. 3 is a longitudinal section view of the battery case and the battery holder when the battery is inserted,

FIG. 4 is a rear view of the assembly according to the embodiment,

FIG. 5 is a top view of the assembly according to the embodiment,

FIG. 6 is a perspective view of a battery holder having two batteries for an aircraft,

FIG. 7 is a bottom view of the battery,

FIG. 8 is a top view of a battery compartment of the battery holder,

Each of FIGS. 9A and 9B shows a lock in the open and closed state,

FIG. 10 is a perspective section view of a battery case and a battery holder before they are assembled according to another embodiment,

FIG. 11A is a cross-sectional view of a contacting of the battery case and the battery holder according to the further embodiment before mounting, and

FIG. 11B is a cross-sectional view of a contacting of the battery case and the battery holder according to the further embodiment after mounting.

### DETAILED DESCRIPTION

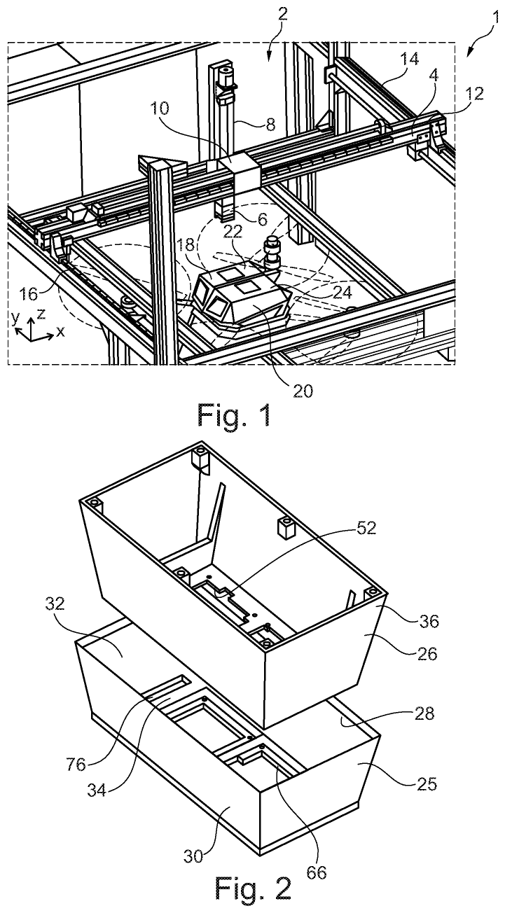

According to FIG. 1, a hangar 1 is illustrated with parts of the walls of the hangar 1 being not shown for convenience so that the assembly 2 disposed therein can be seen. The assembly 2 has a gantry robot in the form of a gantry area robot 4. The latter includes a gripping tool 6 disposed on a gantry arm 8. The gantry arm 8 is supported, in turn, on a slide 10 to be axially displaceable. The gantry arm 8 can perform a lifting movement in the vertical direction via an actor. The slide 10 is supported, in turn, on a crossbeam 12 to be displaceable in an X-direction. It can be moved together with the gantry arm 8 along the crossbeam 12 via an actor. The crossbeam 12 is again disposed to be displaceable on two beams 14, 16. They extend transversely to the crossbeam 12. The crossbeam 12 can be displaced along the beams 14, 16 in a Y-direction. Thus, the slide 10 can be moved with the gripping tool 6 in a X-Y plane. An actor is also provided for moving the crossbeam 12. The beams 14, 16 are disposed via sections above a work surface. On the work surface, an aircraft in the form of a multicopter 18 is provided which is designed as a quadcopter. An assembly 20 in which two batteries 22, 24 are disposed is fastened between the rotors on an upper side of the multicopter 18. A respective battery 22, 24 can be removed from the assembly 20 via the gripping tool 6 provided above the batteries. For this purpose, the gripping tool 6 is appropriately positioned above the battery 22 or 24 to be removed via the gantry area robot 4. The gantry arm 8 is then moved downwards, with the gripping tool 6 engaging in a lifting means of the battery 22 or 24. Then, gripper jaws of the gripping tool 6 engage behind the lifting means. Subsequently, the gripping tool 6 is moved upwards along with the battery 22 or 24 via the gantry arm 8 and is thus removed from the assembly 20. The battery 22 or 24 held by the gripping tool 6 can subsequently be moved to a preferred position, such as a charging station, via the gantry area robot 4.

According to FIG. 2, a component of the assembly 20 is illustrated in the form of a battery holder 25. In addition, part of a battery case 26 of the battery 22 of FIG. 1 is shown. The battery holder 25 limits a battery compartment 28 into which at least parts of the battery case 26 can be inserted. The battery holder 25 includes a frustoconical outer surface 30 and a frustoconical inner surface 32. As a result, the battery compartment 28 widens in an upward direction. From the bottom, the battery compartment 28 is limited by a base having a bottom surface 34. The battery case 26 has a frustoconical outer surface 36. The outer surface 36 and the inner surface 32 are designed so that, when the battery case 26 is inserted, said surfaces are fully adjacent to each other to enable a form fit. In other words, the battery case 26 can be positively inserted into the battery compartment 28. The frustoconical design of the outer surface 36 and the inner surface 32 renders a comparatively rough positioning of the battery case 26 sufficient for inserting the battery 22 into the battery compartment 28.

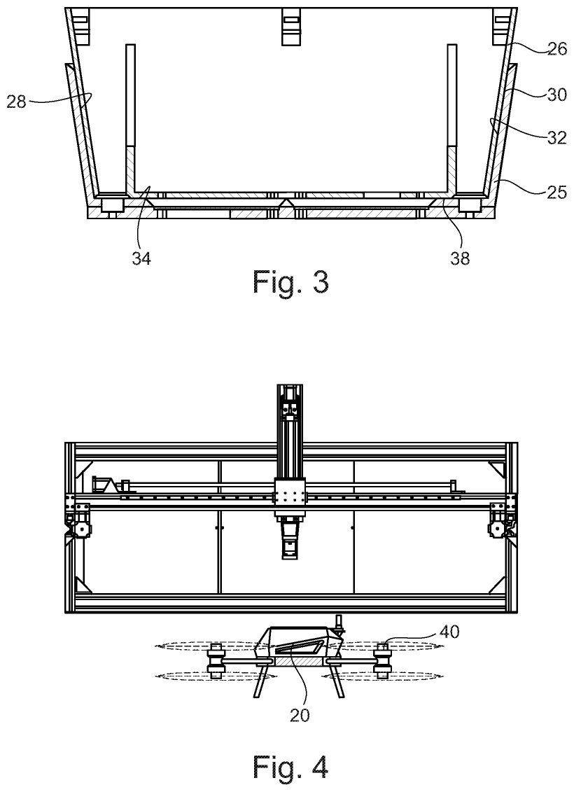

FIG. 3 illustrates a longitudinal section of the battery holder 25 with the battery case 26 in the inserted state. The outer surface 30 is fully adjacent to the inner surface 32. Moreover, a bottom surface 34 of the battery holder 25 and a lower cover surface 38 of the battery case 26 are partly adjacent to each other. A height of the battery case 26 is larger than a height of the battery compartment 28. Thus, the battery case 26 in the inserted state protrudes toward the top.

According to FIG. 4, the lateral view reveals that the assembly 20 is accessible above the rotors 40 of the multicopter 18.

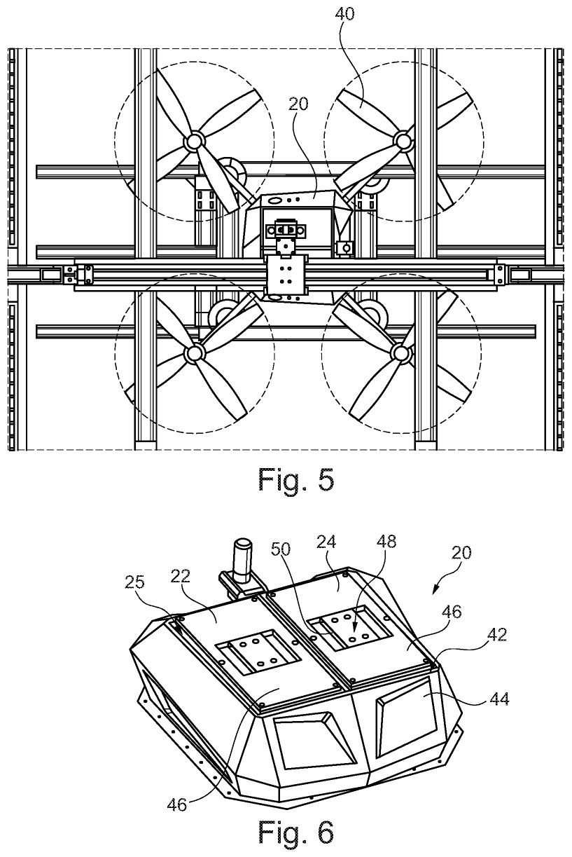

FIG. 5 reveals that the assembly 20 is disposed between and spaced apart from the rotors 40.

According to FIG. 6, the assembly 20 is shown in a perspective view. It has two battery holders 25 and 42 which include the batteries 22 and 24. The battery holders 25 and 42 are additionally encompassed by an outer casing for the purpose of protection. The latter is open toward the top so that the batteries 22 and 24 are completely freely accessible. It would be conceivable that the outer casing 44 is closed on the lower side, such as by a panel. Apart from the protective function, the outer casing 44 also has an aerodynamic function and a design function. Aerodynamics and design are consequently independent of the configuration of the battery holders 25 and 42. It is further visible that the batteries 22 and 34 include a battery cover 46. They are detachably connected to a respective battery case 26 through appropriate means such as screws, see FIG. 2. In each battery cover 46 a lifting means 48 is provided which consists of two gripping grooves behind which the gripping tool 6 of FIG. 1 can engage. The lifting means 48 is designed, when engaging behind it, so that it is arranged between gripper jaws of the gripping tool 6. The lifting means 48 is arranged centrally at the battery cover 46 so that, when the respective battery 22, 24 is moved via the lifting tool 6, it is balanced and has a preferably constant orientation.

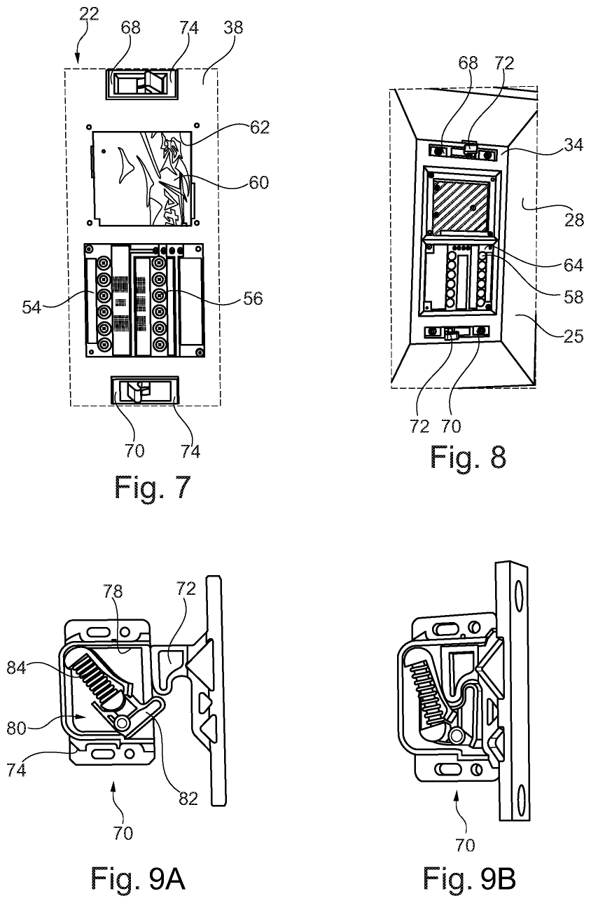

According to FIG. 7, the cover surface 38 of the battery 22 is shown from the bottom. In or on a contact recess 52 visible in FIG. 2 a PCB 54 or printed circuit board including contacts 56 is provided. According to FIG. 7, each contact 56 is designed as a pin protruding from the printed circuit board 54 and, thus, from the cover surface 38. The contacts 56 are resilient and spring-biased in the shown position. They are axially displaceable against the spring force toward the interior of the battery 22 when they are appropriately mechanically loaded. The contacts 56 are arranged in two rows extending in parallel distance to each other. When inserted, the contacts 56 abut on contact surfaces 58, see FIG. 8, of the battery compartment 28, as will be illustrated below. Further, according to FIG. 7 an accumulator pack 60 can be seen through the recess 62. The recess 62 can be closed by a lid, for example.

According to FIG. 8, the contact faces 58 are formed on a printed circuit board 64 which is provided on or in the recess 66 shown in FIG. 2. The recess 66 is introduced into the bottom surface 34 and completely penetrates the battery holder 25. The printed circuit board 64 thus can be connected to electronic components and parts of the multicopter 18 of FIG. 1 via the recess 66. The contact faces 58 are located in a common plane and extend in parallel to or at a parallel distance from the bottom surface 34 according to FIG. 8. When the battery 22 is inserted, each contact 56 is associated with a respective contact face 58. The contacts 56 then contact a respective contact face 58 mechanically and electrically. Therefore, the contact faces 58 are arranged, corresponding to the contacts 56, in two rows provided in parallel distance to each other. The resilient design of the contacts 56 allows to compensate for tolerances in a simple manner.

For tightly fixing the batteries 22, 24 in the inserted state in the respective battery holder 25, 42, see also FIG. 6, two locks 68, 70 are provided. Each lock 68, 70 has a hook 72 provided at the bottom surface 34 of the battery holder 25 according to FIG. 8. A respective hook receptacle 74 is associated with each hook 72. The hook receptacles 74 are configured in the cover surface 38 of the battery 22. In the inserted state, a respective hook 72 engages in a respective hook receptacle 74. Hook recesses 76 are formed in the bottom surface 34 according to FIG. 2 for securing the hooks 72 to the battery holder 25. The hook receptacles 74 protrude from the cover surface 38 into the interior of the battery 22.

According to FIG. 9A, the lock 70 is illustrated in the open state and according to FIG. 9B it is shown in the closed state in cross-section. In accordance with FIG. 9A, the hook receptacle 74 includes a receiving space 78 for the hook 72 where a holding mechanism 80 is provided. The latter has an L-shaped lever 82 rotatably supported in the receiving space 78. Spring force is applied to the lever 82 via a spring 84, the spring 84 being supported in the receiving space 78. When the hook 72 immerses into the receiving space 78 during insertion of the battery 22 of FIG. 7, the lever 82 is rotated over the hook 72 and the spring 84 is tensioned. In the inserted state, the hook 72 and the lever 82, see FIG. 9B, mutually engage behind each other and a clamping force is additionally applied to the lever 82 via the spring 84. For guiding the hook 72 out of the receiving space 78, it is necessary to overcome the clamping force. This can be done by the gantry area robot 4 including the gripping tool 6. As a result, for releasing the positional fixation of the battery 22 it is only required to apply a certain lifting force via the gripping tool 6 to the battery 22.

The design of the assembly 20 allows the batteries 22 and 24, see FIG. 1, to be easily removed and re-inserted axially in the vertical direction. This is made possible by the combination of various functionalities. The tapered design of the battery case 26 and the battery compartment 8 results in easy centering and in easy insertion of the battery 22. The contacts 56 and the contact faces 58 enable safe contacting which is effectuated by the design and the arrangement simply when inserting the battery 22 into the battery compartment 28. The battery 22 is automatically closed by means of the advantageous design of the lock 70. Equally advantageously, the battery can be removed, because the locks 70 release automatically from a certain leverage. The advantageous design of the assembly 20 and the simple insertion and removal of the batteries 22, 24 in the form of “plug-and-play” also allow to use a robot of simple design in the form of the gantry area robot 4.

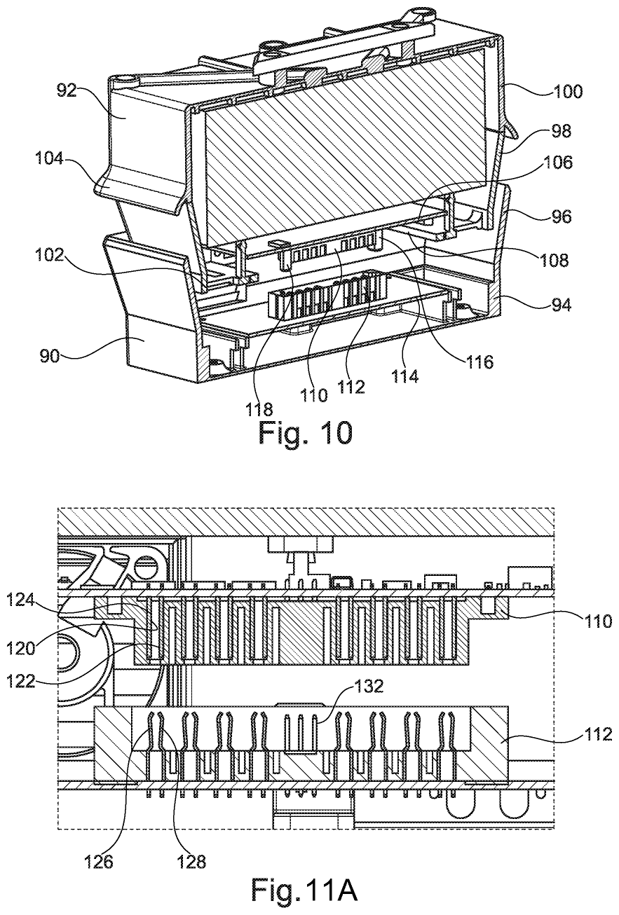

FIG. 10 illustrates a battery holder 90 and a battery 92 according to a further embodiment before they are assembled. The battery holder 90 has a lower sleeve-shaped base section 94 to the side walls of which an upper centering section 96 is integrally connected. The centering section is designed to be sleeve-shaped with a frustoconical wall. A battery case of the battery 92 is made up of at least two parts having a lower sleeve-shaped centering section 98 and an upper sleeve-shaped base section 100. The centering sections 96 and 98 are adjusted to each other specifically in such a way that the walls have an approximately equal gradient to fulfil the centering function. At the bottom of the centering section 98 of the battery 92, a contact section 102 being approximately hollow-cylindrical is integrally connected. A peripheral radial collar 104 which overlaps the battery holder 90 for sealing after insertion is formed at the upper base section 100.

A printed circuit board 106 in which a large side faces downwards is fastened at the battery 92. The large side is accessible from the bottom through a housing opening 108. The printed circuit board 106 is arranged to be offset inwardly from a bottom side of the battery 92. A connector block 110 tightly connected to the printed circuit board 106 extends downwards from the downwardly facing large side, wherein said connector block 110 is arranged completely inside the battery case at least partly or preferably for better protection. In other words, the printed circuit board thus can be inwardly offset, which creates a space accessible from below for the connector block 110. For the connector block 11 a connector receiving block 112 is provided which is fastened to a printed circuit board 114 of the battery holder 90. The printed circuit board 114 is fastened inside the battery holder 90.

When inserting the battery 92 into the battery holder 90, the connector block 100 immerses in the connector receiving block 112. After mounting, the connector receiving block 112 is at least partially immersed in the battery 92. For centering, two centering pins 116, 118 are configured on the connector block 100 and protrude away from the connector block 100. A corresponding pin receptacle is formed for each of the centering pins 116, 118 at the connector receiving block 112.

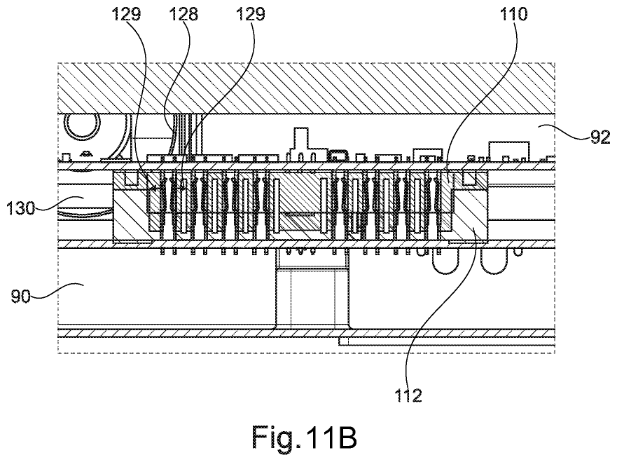

FIG. 11A illustrates the area of the connector block 110 and the connector receiving block 112 before insertion of the battery in cross-section. In the connector block 110 plural contact pairings each having two contact faces 120, 122 are provided. The latter are formed on contact plates 124. The contact faces 120, 122 of each contact pairing point towards each other and/or extend at a parallel distance and/or limit a holding space. The contact plates 124 rest on the connector block 110 and are embedded in the same, for example.

According to FIG. 11A, the connector receiving block 112 includes two contact springs 126, 128 for a respective contact pairing. Each of said contact springs 126, 128 is immersed—after insertion of the battery 92—in the corresponding holding space of two contact faces 120, 122, the respective contact spring 126, 128 being elastically adjacent to the respective contact face 122, 120, preferably via a line contact. For example, a total of 8 contact pairings is provided.

According to FIG. 11B, the assembled state of the connector receiving block 112 and the connector block 110 is shown. The force effect of the contact springs 126, 128 on the contact faces 120, 122 is shown schematically and simplified by arrows 129. The force effect acts approximately in parallel to the printed circuit board and is supported over a large area by the blocks 112, 110. The blocks 110, 112 have a frame design and can take up a major part of the forces or the entire forces in themselves and in this way can relieve the printed circuit board. It has turned out that, despite a high current flow—such as of 120 A between the contact pairings—, comparatively low temperatures, e.g., about 30° C., occur. The plural contact pairings serve to split the current flow, for example. The combination of low temperature and low mechanical load in the direct direction to the printed circuit board results in high reliability. If, however, contacts are provided which result in high temperatures of e.g. 120° C. and mechanically apply force to the printed circuit board directly in the direction of the latter, this could result in deformations of the printed circuit boards and the housings when such a battery is used with such a battery holder, which could interrupt an electric current flow, for example.

From FIG. 11B it is further visible that a fan opening 128 of the battery 92 is arranged opposite to a ventilation opening 130 of the battery holder 90 after mounting, whereby heat can be easily dissipated with low resistance through an airflow. An air inlet can be appropriately formed at a different location, i.e., can include a ventilation opening at the battery holder and an opposite fan opening at the battery.

According to FIG. 11A, the printed circuit board 114 of the battery holder 90 includes data pins 132 which extend perpendicularly away from and are mechanically and electrically connected to the printed circuit board 114. The data pins 132 are supported at their base by the connector receiving block 112. A pin receptacle having a respective data contact face is provided for each data pin 132. The pin receptacles are designed on the connector block 110, with the data contact faces being mechanically and electrically connected to the printed circuit board 106.

1. An assembly for removing a battery from a vehicle and for inserting a battery into the vehicle, comprising a robot having a lifting tool which is movable via the robot and which is provided for holding and moving a battery, wherein at least one battery is provided for the vehicle which has a battery case on which a lifting means adapted to be gripped by the lifting tool is formed, wherein a battery holder is provided which is adapted to be fastened to the vehicle via a fastener and includes at least one battery compartment into which the battery can be inserted and from which it can be removed via the lifting tool, wherein the robot is a gantry robot including a gantry arm with the lifting tool, wherein the battery compartment includes a compartment opening which is accessible from above and through which the battery can be inserted and removed, characterized in that the battery compartment tapers starting from the compartment opening to enable the battery to be centered during insertion.

2. The assembly according to claim 1, wherein a work surface accessible from above is provided on which the vehicle can be arranged, wherein the lifting tool can be arranged above the work surface by the gantry robot to lift the battery upwards out of the vehicle or to insert it into the vehicle from above.

3. (canceled)

4. (canceled)

5. The assembly according to claim 1, wherein, in the bottom of the battery compartment, contacts are formed which interact with contacts of the battery, when the battery is inserted, and wherein the battery includes contacts which interact with the contacts of the battery compartment on a lower cover surface of the battery case.

6. The assembly according to claim 1, wherein the battery case takes a downwardly tapered shape to allow threading of the battery when it is inserted into the battery compartment.

7. The assembly according to claim 1, wherein the battery when inserted can be fixed via at least one lock in the battery compartment which lock is designed so that it opens automatically from a predetermined force acting on the battery in the lifting direction, and/or that it closes automatically when the battery is inserted into the battery compartment.

8. The assembly according to claim 6, wherein the contacts of one component in the form of the or the battery holder are designed as pins each of which interacts with one of the contacts of the other component in the form of the battery holder or the battery configured as a contact face, with the pins being resilient.

9. A hangar comprising the assembly according to claim 1, wherein the vehicle is an aircraft and the assembly is disposed inside the hangar.

10. An assembly comprising a battery holder and a battery for a vehicle, wherein a battery case of the battery takes a downwardly tapered shape and/or wherein a battery compartment of the battery holder tapers downwards from an upper compartment opening, and/or wherein at least one lock is provided via which the battery when inserted can be fixed in the battery compartment, wherein the lock is configured so that it opens automatically from a predetermined force acting on the battery in the lifting direction, and/or wherein contact faces which are tightly connected to a printed circuit board and extend obliquely or perpendicularly away from the printed circuit board are configured on the battery for electrical contacting, wherein a respective contact spring is designed for each contact face at the battery holder.
